(19) United States
(12) Patent Application Publication
(10) Pub. No.: US 2025/0391332 A1
(43) Pub. Date: Dec. 25, 2025

(54) POWER VOLTAGE GENERATOR, DISPLAY APPARATUS INCLUDING THE SAME AND ELECTRONIC APPARATUS INCLUDING THE SAME

(71) Applicants: Samsung Display Co., LTD., Yongin-si (KR); AnaPass Inc., Seoul (KR)

(72) Inventors: JIWOONG KIM, Yongin-si (KR); Changwhan Kim, Seoul (KR); Joonbae Park, Seoul (KR); OHJO KWON, Yongin-si (KR); Yongjae Lee, Yongin-si (KR)

(21) Appl. No.: 19/097,035

(22) Filed: Apr. 1, 2025

(30) Foreign Application Priority Data
Jun. 19, 2024 (KR) 10-2024-0079912

(51) Int. Cl. G09G 3/32

(52) U.S. Cl. CPC G09G 3/32; G09G 2310/08; G09G 2330/028

(57) ABSTRACT

A display apparatus includes a display panel including a pixel and a display panel driver which drives the display panel. The display panel driver includes a voltage generator which applies a power voltage based on a power current to the display panel. When the pixel emits light, the voltage generator generates a compensation current. The power voltage is applied to the display panel based on the compensation current.

This application claims priority to Korean Patent Application No. 10-2024-0079912, filed on Jun. 19, 2024, and all the benefits accruing therefrom under 35 U.S.C. § 119, the content of which in its entirety is herein incorporated by reference.

### BACKGROUND

### 1. Field

Embodiments of the invention relate to a voltage generator, a display apparatus including the voltage generator and an electronic apparatus including the voltage generator. More particularly, embodiments of the invention relate to a voltage generator, a display apparatus including the voltage generator and an electronic apparatus including the voltage generator with improved display quality.

### 2. Description of the Related Art

Generally, a display apparatus includes a display panel and a display panel driver. The display panel typically includes a plurality of gate lines, a plurality of data lines, a plurality of emission lines and a plurality of pixels. The display panel driver typically includes a gate driver for providing a gate signal to the gate lines, a data driver for providing a data voltage to the data lines, an emission driver for providing an emission signal to the emission lines and a driving controller for controlling the gate driver, the data driver and the emission driver.

### SUMMARY

Generally, voltage ripples may occur in a power voltage applied to pixels during an emission period, and a display quality of a display panel may deteriorate due to the voltage ripples.

Embodiments of the invention provide a voltage generator reducing a voltage ripple through a compensation current and improving a display quality.

Embodiments of the invention also provide a display apparatus including the voltage generator,

Embodiments of the invention also provide an electronic apparatus including the voltage generator.

According to embodiments, a display apparatus includes a display panel including a pixel and a display panel driver which drives the display panel. In such embodiments, the display panel driver includes a voltage generator which applies a power voltage based on a power current to the display panel. In such embodiments, when the pixel emits light, the voltage generator generates a compensation current. In such embodiments, the power voltage is applied to the display panel based on the compensation current.

In an embodiment, the display panel driver may further include an emission driver which outputs an emission signal and a driving controller which controls the voltage generator and the emission driver. In such an embodiment, The pixel may emit light in response to the emission signal. In such an embodiment, the compensation current may be generated during a period in which the emission signal has an activation level.

In an embodiment, the driving controller may output an emission start signal to the emission driver. In such an embodiment, the emission driver may generate the emission signal based on the emission start signal. In such an embodiment, the compensation current may be generated based on the emission start signal.

In an embodiment, the driving controller may output an emission start signal to the voltage generator. In such an embodiment, the emission driver may generate the emission signal based on the emission start signal. In such an embodiment, the compensation current may be generated based on the emission start signal.

In an embodiment, the emission signal may include first to N-th emission signals. In such an embodiment, the first to N-th emission signals may be generated based on an emission start signal and an emission clock signal from the driving controller. In such an embodiment, the compensation current may be generated based on the emission clock signal.

In an embodiment, when the emission clock signal has a clock low level, the compensation current may be generated.

In an embodiment, a period in which the compensation current is generated may be synchronized to the emission clock signal.

In an embodiment, the period in which the compensation current is generated may be consistent with a period in which the emission clock signal has the clock low level.

In an embodiment, a frame period in which the pixel is driven may include a writing period in which a data voltage is applied and an emission period in which the pixel emits light based on the data voltage. In such an embodiment, the compensation current may be generated in the emission period.

In an embodiment, a frame period in which the pixel is driven may include a writing period in which a data voltage is applied and an emission period in which the pixel emits light based on the data voltage. In such an embodiment, the voltage generator may output the compensation current to the display panel in the emission period.

In an embodiment, the voltage generator may include a voltage receiving block which receives a supply voltage and outputs an output voltage based on the supply voltage, a voltage compensation block which generates the compensation current based on an emission start signal and a voltage calculating block which outputs the power current based on the output voltage and the compensation current to the display panel.

In an embodiment, the voltage generator may include a voltage receiving block which receives a supply voltage and outputs an output voltage based on the supply voltage, a voltage compensation block which generates the compensation current based on an emission clock signal and a voltage calculating block which outputs the power current based on the output voltage and the compensation current to the display panel.

In an embodiment, the voltage generator may include a voltage outputting block which receives a supply voltage and outputs the power current and a voltage compensation block which outputs the compensation current to the display panel in response to an emission start signal.

In an embodiment, power voltage may include a first power voltage and a second power voltage, and the first power voltage is applied based on the power current. In such an embodiment, the pixel may include a first transistor which generates a driving current based on a data voltage, a second transistor which applies the data voltage to the first transistor in response to a gate signal, a third transistor which applies the first power voltage to the first transistor in response to an emission signal and a light emitting element which emits light based on the driving current.

According to embodiments, a voltage generator includes a voltage outputting block which receives a supply voltage and outputs a power current to a display panel and a voltage compensation block which generates a compensation current based on an emission clock signal. In such an embodiment, the compensation current is outputted in an emission period.

In an embodiment, the voltage outputting block may include a voltage receiving block which receives the supply voltage and outputs an output voltage based on the supply voltage and a voltage calculating block which receives the output voltage and the compensation current, and outputs the power current based on the output voltage and the compensation current.

In an embodiment, the voltage compensation block may output the compensation current to the display panel.

According to embodiments, a voltage generator includes a voltage outputting block which receives a supply voltage and outputs a power current to a display panel and a voltage compensation block which generates a compensation current based on an emission start signal. In such an embodiment, the compensation current is outputted in an emission period.

In an embodiment, the voltage outputting block may include a voltage receiving block which receives the supply voltage and outputs an output voltage based on the supply voltage and a voltage calculating block which receives the output voltage and the compensation current, and outputs the power current based on the output voltage and the compensation current.

According to embodiments, an electronic apparatus includes a display panel including a pixel, a display panel driver which drives the display panel based on an input control signal and a processor which outputs the input control signal. In such embodiments, the display panel driver includes a voltage generator which applies a power voltage based on a power current to the display panel. In such embodiments, when the pixel emits light, the voltage generator generates a compensation current. In such embodiments, the power voltage is applied to the display panel based on the compensation current.

In an embodiment of the invention, as described above, the compensation current may be outputted in response to the emission start signal. For example, in the emission period, the ripple current may occur. In such an embodiment, the phase of the compensation current may be opposite to the phase of the ripple current. In such an embodiment, the power current may be generated based on the compensation current. Accordingly, an effect of the ripple current may be compensated in the power current. In such an embodiment, the effect of the ripple current may be compensated in the power current, such that the power current may be maintained stably. The power current may be maintained stably, such that the power voltage (e.g., the first power voltage) may be maintained stably. Accordingly, a driving stability of the pixel may be improved, and thus, a display quality of the display panel may be improved.

In an embodiment of the invention, the compensation current may be outputted in response to the emission start signal. For example, a period in which the compensation current is generated may be synchronized to a period in which the emission start signal has an activation level. In such an embodiment, the compensation current may be outputted based on the emission start signal, such that the display panel driver may not include a driver for generating a signal for outputting the compensation current. Accordingly, an integration of the display panel driver may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display apparatus according to embodiments of the invention.

FIG. 2 is a block diagram illustrating a ripple current when a pixel of a conventional display apparatus emits light.

FIG. 3 is a block diagram illustrating an embodiment of a display panel and a voltage generator included in a display apparatus of FIG. 1.

FIG. 4 is a circuit diagram illustrating an embodiment of a pixel included a display apparatus of FIG. 1.

FIG. 5 is a signal timing diagram illustrating a frame period in which a pixel of FIG. 4 is driven.

FIG. 6 is a signal timing diagram illustrating emission signals generated from an emission driver of FIG. 1.

FIG. 7 is a signal timing diagram illustrating a frame period in which a pixel of FIG. 4 is driven.

FIG. 8 is a signal timing diagram illustrating a power current outputted from a voltage generator of FIG. 3 and a power current outputted from a voltage generator included in a conventional display apparatus.

FIG. 9 is a block diagram illustrating an embodiment of a display panel and a voltage generator included in a display apparatus of FIG. 1.

FIG. 10 is a circuit diagram illustrating an embodiment of voltage receiving block of FIG. 3.

FIG. 11 is a circuit diagram illustrating an embodiment of pixel included in a display apparatus of FIG. 1.

FIG. 12 is a block diagram illustrating an electronic apparatus according to an embodiment of the invention.

FIG. 13 is a diagram illustrating an embodiment in which the electronic apparatus of FIG. 12 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

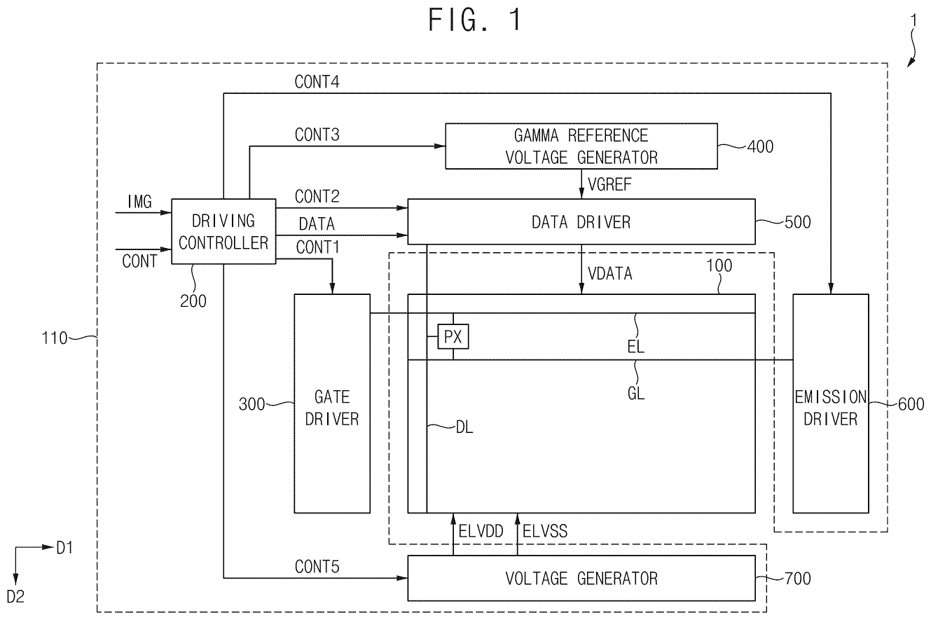

FIG. 1 is a block diagram illustrating a display apparatus 1 according to embodiments of the invention.

Referring to FIG. 1, an embodiment of the display apparatus 1 may include a display panel 100 and a display panel driver 110. The display panel driver 110 may include a driving controller 200, a gate driver 300, a gamma reference voltage generator 400, a data driver 500, an emission driver 600 and a voltage generator 700.

The display panel 100 may include (or be divided into) a display region on which an image is displayed and a peripheral region adjacent to the display region.

The display panel 100 may include a plurality of gate lines GL, plurality of emission lines EL, a plurality of data lines DL and a plurality of pixels PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

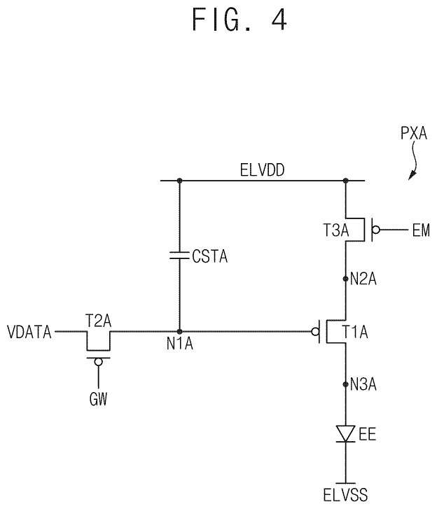

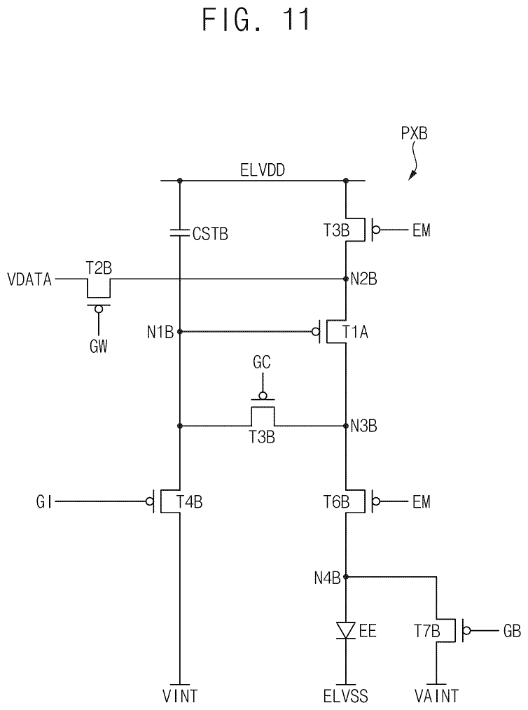

The gate driver 300 may generate gate signals driving the gate lines GL in response to the first control signal CONT1 received from the driving controller 200. The gate driver 300 may output the gate signals to the gate lines GL. In an embodiment, for example, the gate signals may include a write gate signal GW of FIG. 4, an initialization gate signal GI of FIG. 11, a compensation gate signal GC of FIG. 11 and a bias gate signal GB of FIG. 11.

In an embodiment, the gate driver 300 may be disposed in the peripheral region. In an embodiment, the gate driver 300 may be integrated (or integrally formed) in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

In an embodiment, the data driver 500 may be disposed in the peripheral region. In an embodiment, the data driver 500 may be integrated (or integrally formed) in the peripheral region.

The emission driver 600 may generate emission signal EM of FIG. 4 in response to the fourth control signal CONT4 received from the driving controller 200. The emission driver 600 may output the emission signal to the display panel 100. The fourth control signal CONT4 may include an emission start signal and an emission clock signal.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other.

The voltage generator 700 may generate power voltages ELVDD and ELVSS in response to the fifth control signal CONT5 received from the driving controller 200. The power voltages ELVDD and ELVSS may include a first power voltage ELVDD and a second power voltage ELVSS. The first power voltage ELVDD may be applied to the display panel 100 based on a power current. The fifth control signal CONT5 may include an emission start signal and an emission clock signal. In an embodiment, for example, the fifth control signal CONT5 may be called as a power control signal.

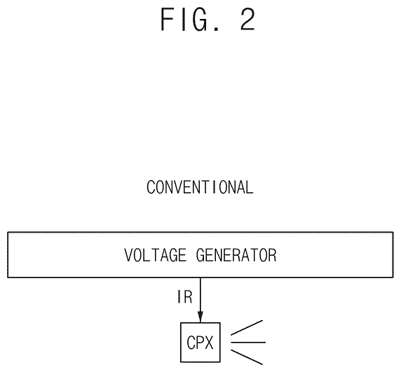

FIG. 2 is a block diagram illustrating a ripple current IR when a pixel CPX of a conventional display apparatus emits light.

Referring to FIG. 2, when a pixel CPX of a conventional display apparatus emits light, a ripple current IR may occur by a characteristic of transistor included in the pixel CPX. For example, when the pixel CPX emits light, an emission transistor connected to a power line may be turned on. When the emission transistor is turned on, the ripple current IR may occur. The ripple current IR may flow through the power line connected to a voltage generator and the pixel CPX. When the ripple current IR occurs, a power voltage generated by the voltage generator may be changed. For example, a voltage ripple may occur in the power voltage. When the voltage ripple occurs, a stability of the power voltage applied to the pixel CPX may be deteriorated. When the stability of the power voltage applied to the pixel CPX is deteriorated, a display quality of a display panel included in the conventional display apparatus may be deteriorated.

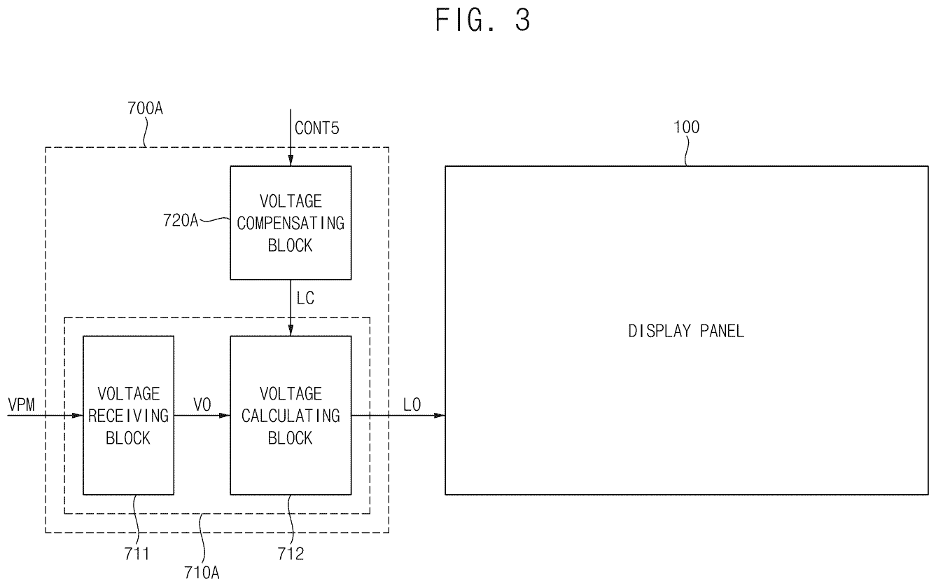

FIG. 3 is a block diagram illustrating an embodiment of a display panel 100 and a voltage generator 700 included in a display apparatus of FIG. 1.

Referring to FIG. 1 to FIG. 3, in an embodiment, a voltage generator 700A may include a voltage outputting block 710A and a voltage compensation block 720A. The voltage outputting block 710A may include a voltage receiving block 711 and a voltage calculating block 712.

The voltage receiving block 711 may receive a supply voltage VPM. In an embodiment, for example, the voltage receiving block 711 may receive the supply voltage VPM from a power management integrated circuit (PMIC). The voltage receiving block 711 may generate an output voltage VO based on the supply voltage VPM. In an embodiment, for example, the voltage receiving block 711 may convert the supply voltage VOM to the output voltage VO. In an embodiment, for example, the output voltage VO may be higher than the supply voltage VPM. In an embodiment, for example, the output voltage VO may be lower than the supply voltage VPM. In an embodiment, for example, the output voltage VO may be substantially same as the supply voltage VPM. In an embodiment, for example, the voltage receiving block 711 may include a regulator circuit.

The voltage calculating block 712 may receive the output voltage VO. The voltage calculating block 712 may receive a compensation current LC from the voltage compensation block 720A. The voltage calculating block 712 may output a power current LO to the display panel 100 based on the output voltage VO and the compensation current LC.

The voltage compensation block 720A may output a compensation current LC in response to the fifth control signal CONT5. A phase of the compensation current LC may be opposite to a phase of the ripple current IR. In an embodiment, for example, the compensation current LC may be set by the user. In an embodiment, for example, the compensation current LC may be set based on (or by considering) panel characteristics of the display panel 100.

In an embodiment, the compensation current LC may be output in an emission period. In an embodiment, the compensation current LC may be outputted in response to the emission start signal EMC. In an embodiment, for example, the compensation current LC may be generated in response to the emission start signal EMC. In an embodiment, the compensation current LC may be outputted in response to the emission clock signal ECLK. In an embodiment, for example, the compensation current LC may be generated in response to the emission clock signal ECLK.

FIG. 4 is a circuit diagram illustrating an embodiment of a pixel PX included a display apparatus 1 of FIG. 1.

Referring to FIG. 1 and FIG. 4, an embodiment of the pixel PX may include first to third transistors T1A, T2A and T3A, a storage capacitor CSTA and a light emitting element EE.

The first transistor TIA may include a control electrode connected to a first node NIA, a first electrode connected to a second node N2A and a second electrode connected to a third node N3A. The first transistor TIA may generate a driving current based on a voltage of the first node NIA. For example, the first transistor TIA may be called as a driving transistor.

The second transistor T2A may include a control electrode that receives the writing gate signal GW, a first electrode that receives the data voltage VDATA and a second electrode connected to the first node NIA. The second transistor T2A may apply the data voltage to the first node NIA in response to the write gate signal GW. For example, the second transistor T2A may be called as writing transistor.

The third transistor T3A may include a control electrode that receives the emission signal EM, a first electrode that receives the first power voltage ELVDD and a second electrode connected to the second node N2A. The third transistor T3A may apply the first power voltage ELVDD to the second node N2A in response to the emission signal EM. For example, the third transistor T3A may be called as an emission transistor.

The storage capacitor CST may include a first electrode that receives the first power voltage ELVDD and a second electrode connected to the first node NIA. The storage capacitor CSTA may store a voltage of the first node NIA.

The light emitting element EE may include a first electrode connected to the third node N3A and a second electrode that receives the second power voltage ELVSS. The light emitting element EE may emit light based on the driving current.

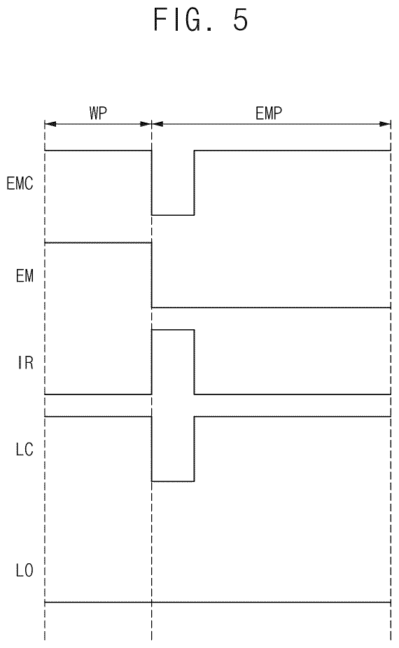

FIG. 5 is a signal timing diagram illustrating a frame period in which a pixel PX of FIG. 4 is driven.

Referring to FIG. 1 to FIG. 5, in an embodiment, a frame period in which the pixel PX is driven may include a writing period WP and an emission period EMP.

In the writing period WP, the data voltage VDATA may be applied to the pixel PXA. In the writing period WP, the writing gate signal GW may have an activation level. In the writing period WP, the data voltage VDATA may be applied to the first node NIA in response to the write gate signal GW.

In the emission period EMP, the emission signal EM may have an activation level. In the emission period EMP, the third transistor T3A may apply the first power voltage ELVDD to the second node N2A in response to the emission signal EM. Accordingly, the light emitting element EE may emit light based on the driving current. The emission signal EM may be generated based on the emission start signal EMC.

In an embodiment, the compensation current LC may be outputted in response to the emission start signal EMC. In an embodiment, for example, in the emission period EMP, the ripple current IR may occur. In an embodiment, the phase of the compensation current LC may be opposite to the phase of the ripple current IR. The power current LO may be generated based on the compensation current LC. Accordingly, an effect of the ripple current IR may be considered or compensated in the power current LO. In such an embodiment, the effect of the ripple current IR may be considered or compensated in the power current LO, such that the power current LO may be maintained stably. In such an embodiment, the power current LO may be maintained stably, such that the power voltage may be maintained stably. In an embodiment, for example, the first power voltage ELVDD may be maintained stably. Accordingly, a driving stability of the pixel PXA may be improved, and thus, a display quality of the display panel 100 may be improved.

In an embodiment, the compensation current LC may be outputted in response to the emission start signal EMC. In an embodiment, for example, a period in which the compensation current LC is generated may be synchronized to a period in which the emission start signal EMC has an activation level. The compensation current LC may be outputted based on the emission start signal EMC, such that the display panel driver 110 may not include a driver for generating a signal for outputting the compensation current LC. Accordingly, an integration of the display panel driver 110 may be improved.

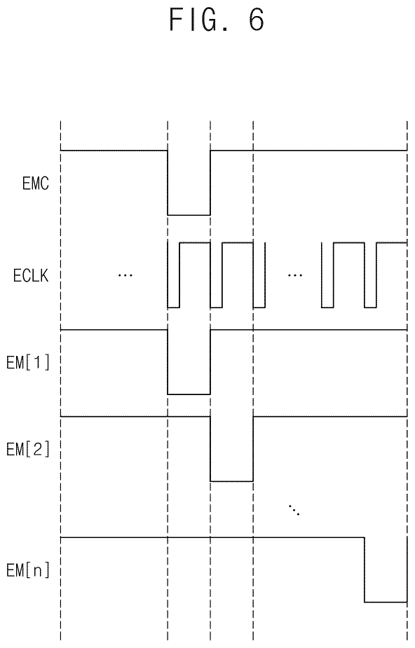

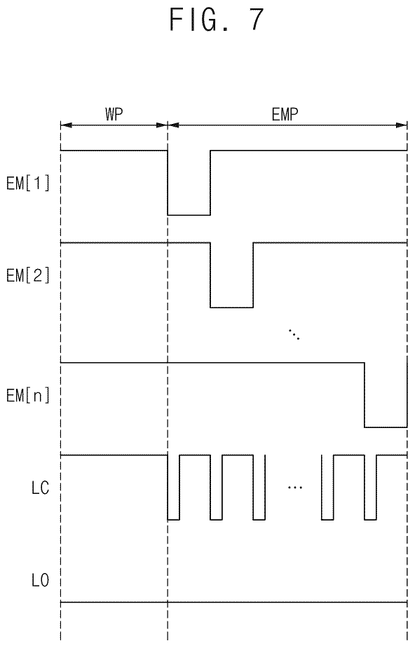

FIG. 6 is a signal timing diagram illustrating emission signals generated from an emission driver 600 of FIG. 1. FIG. 7 is a signal timing diagram illustrating a frame period in which a pixel PXA of FIG. 4 is driven.

Referring to FIG. 1 to FIG. 4, FIG. 6 and FIG. 7, the emission driver 600 may generate first to N-th emission signals EM[1], EM[2] to EM[n], where N is a positive integer. In an embodiment, for example, the first emission signal EM[1] may be applied to a first pixel-row, and the second emission signal EM[2] may be applied to a second pixel-row.

In an embodiment, the compensation current LC may be outputted in response to the emission clock signal ECLK. In an embodiment, for example, in the emission period EMP, the ripple current IR may occur. In such an embodiment, the phase of the compensation current LC may be opposite to the phase of the ripple current IR. In such an embodiment, the power current LO may be generated based on the compensation current LC. Accordingly, an effect of the ripple current IR may be considered or compensated in the power current LO. In such an embodiment, the effect of the ripple current IR may be considered or compensated in the power current LO, such that the power current LO may be maintained stably. In such an embodiment, the power current LO may be maintained stably, such that the power voltage may be maintained stably. In such an embodiment, the first power voltage ELVDD may be maintained stably. Accordingly, a driving stability of the pixel PXA may be improved, and thus, a display quality of the display panel 100 may be improved.

In an embodiment, the compensation current LC may be outputted in response to the emission clock signal ECLK. In an embodiment, for example, a period in which the compensation current LC is generated may be synchronized to a period in which the emission clock signal ECLK has an activation level. The compensation current LC may be outputted based on the emission start signal EMC, such that the display panel driver 110 may not include a driver for generating a signal for outputting the compensation current LC. Accordingly, an integration of the display panel driver 110 may be improved.

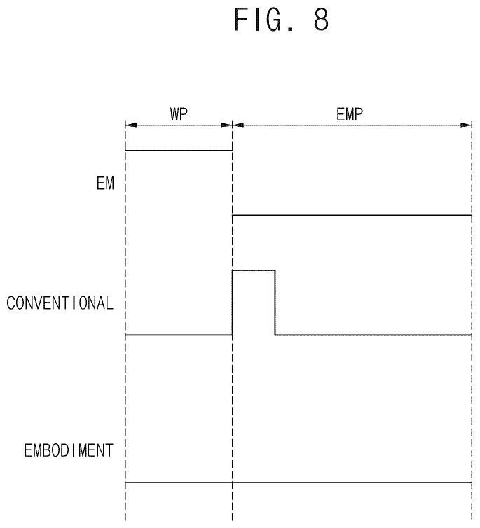

FIG. 8 is a signal timing diagram illustrating a power current outputted from a voltage generator 700A of FIG. 3 and a power current outputted from a voltage generator included in a conventional display apparatus.

Referring to FIG. 1 to FIG. 8, in the emission period EMP, the ripple current IR may occur in the conventional display apparatus. For example, when a pixel CPX emits light, an emission transistor may be turned on. When the emission transistor is turned on, the ripple current IR may occur. When the ripple current IR occurs, a power current outputted from a voltage generator included in the conventional display apparatus may be changed. Accordingly, the power voltage applied to the conventional pixel may be changed. For example, a voltage ripple may occur to the power voltage. When the voltage ripple occurs, a stability of the power voltage applied to the pixel CPX may be deteriorated. When the stability of the power voltage applied to the pixel CPX is deteriorated, a display quality of a display panel included in the conventional display apparatus may be deteriorated.

In an embodiment of the invention, the voltage generator 700A included in the display apparatus 1 may output the compensation current LC in the emission period EMP. The phase of the compensation current LC may be opposite to the phase of the ripple current IR. The power current LO may be generated based on the compensation current LC. Accordingly, an effect of the ripple current IR may be considered to the power current LO. The effect of the ripple current IR may be considered to the power current LO, so that the power current LO may be maintained stably. The power current LO may be maintained stably, such that the power voltage may be maintained stably. In an embodiment, for example, the first power voltage ELVDD may be maintained stably. Accordingly, a driving stability of the pixel PXA may be improved, and thus, a display quality of the display panel 100 may be improved.

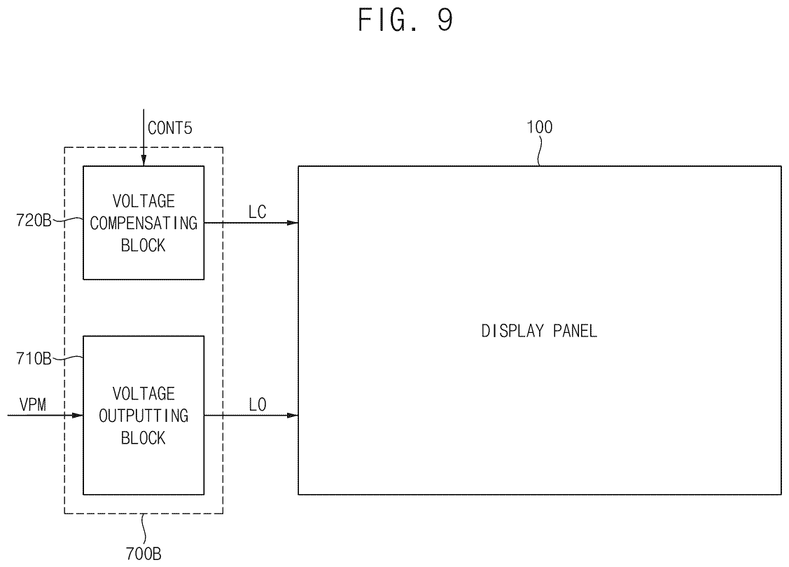

FIG. 9 is a block diagram illustrating an embodiment of a display panel 100 and a voltage generator 700B included in a display apparatus 1 of FIG. 1.

In an embodiment, a voltage generator 700B may include a voltage outputting block 710B and a voltage compensation block 720B.

The embodiment of the voltage generator 700B shown in FIG. 9 is substantially the same as the embodiment described above with reference to FIG. 1 to FIG. 8 except that the voltage compensation block 720B outputs a compensation current LC to the display panel 100. Accordingly, the same or like reference numerals will be used to indicate the same or like elements, and any repetitive detailed description thereof will be omitted.

Referring to FIG. 1, FIG. 2, FIG. 4 to FIG. 9, in an embodiment, the voltage compensation block 720B may output the compensation current LC to the display panel 100. In an embodiment, for example, the voltage compensation block 720B may output the compensation current LC to the power line.

Accordingly, an effect of the ripple current IR may be considered or compensated in the power current LO. In such an embodiment, the effect of the ripple current IR may be considered or compensated in the power current LO, such that the power current LO may be maintained stably. In such an embodiment, the power current LO may be maintained stably, such that the power voltage may be maintained stably. In an embodiment, for example, the first power voltage ELVDD may be maintained stably. Accordingly, a driving stability of the pixel PXA may be improved, and thus, a display quality of the display panel 100 may be improved.

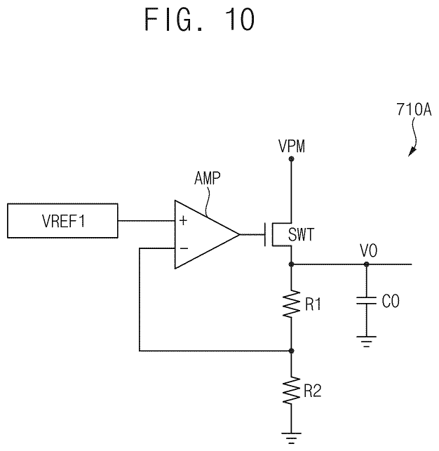

FIG. 10 is a circuit diagram illustrating an embodiment of voltage receiving block 711 of FIG. 3.

Referring to FIG. 1, FIG. 3 and FIG. 10, an embodiment of the voltage receiving block 711 may include a receiving amplifier AMP and a receiving transistor SWT connected to an output node of the receiving amplifier AMP. The receiving transistor SWT may include a control electrode connected to the output node of the receiving amplifier AMP, a first electrode that receives the supply voltage VPM and a second electrode outputting the power voltage.

The voltage receiving block 711 may include a first register R1 including a first terminal connected to the second electrode of the receiving transistor SWT and a second terminal connected to a first input node of the receiving amplifier AMP, a second register R2 including a first terminal connected to the second terminal of the first register R1 and a second terminal connected to a ground, and a stabilization capacitor CO including a first electrode connected to the second electrode of the receiving transistor SWT and a second electrode connected to the ground.

A target voltage VREF1 of the output voltage VO may be applied to the second input node of the receiving amplifier AMP.

FIG. 11 is a circuit diagram illustrating an embodiment of pixel PX included in a display apparatus of FIG. 1.

Referring to FIG. 1 and FIG. 11, an embodiment of a pixel PXB may include a first transistor T1B, a second transistor T2B, a third transistor T3B, a fourth transistor T4B, a fifth transistor T5B, a sixth transistor T6B, a seventh transistor T7B, a storage capacitor CSTB and the light emitting element EE.

The first transistor TIB may include a control electrode connected to a first node N1B, a first electrode connected to a second node N2B and a second electrode connected to a third node N3B. The first transistor TIB may generate a driving current based on a voltage of the first node NIB. For example, the first transistor TB may be called as the driving transistor.

The second transistor T2B may include a control electrode that receives a write gate signal GW, a first electrode that receives the data voltage VDATA and a second electrode connected to the second node N2B. The second transistor T2B may apply the data voltage VDATA to the second node N2B in response to the write gate signal GW. For example, the second transistor T2B may be called as the writing transistor.

The third transistor T3B may include a control electrode that receives the compensation gate signal GC, a first electrode connected to the third node N3B and a second electrode connected to the first node NIB. The third transistor T3B may connect the first node NIB and the third node N3B to each other in response to the compensation gate signal GC. In an embodiment, for example, the third transistor T3B may diode-connect the first transistor TIB in response to the compensation gate signal GC. For example, the third transistor T3B may be called as the compensation transistor.

The fourth transistor T4B may include a control electrode that receives the initialization gate signal GI, a first electrode that receives the initialization voltage VINT and a second electrode connected to the first node NIB. The fourth transistor T4B may apply the initialization voltage VINT to the first node NIB in response to the initialization gate signal GI. For example, the fourth transistor T4B may be called as the initialization transistor.

The fifth transistor T5B may include a control electrode that receives the emission signal EM, a first electrode that receives the first power voltage ELVDD and a second electrode connected to the second node N2. The fifth transistor T5B may apply the first power voltage ELVDD to the second node N2B in response to the emission signal EM. For example, the fifth transistor T5B may be called as a second emission transistor.

The sixth transistor T6B may include a control electrode that receives the emission signal EM, a first electrode connected to the third node N3B and a second electrode connected to a fourth node N4B. The sixth transistor T6B may connect the third node N3B and the fourth node N4B to each other in response to the emission signal EM. For example, the sixth transistor T6B may be called as a first emission transistor.

The seventh transistor T7B may include a control electrode that receives the bias gate signal GB, a first electrode that receives the light emitting element initialization voltage VAINT and a second electrode connected to the fourth node N4B. The seventh transistor T7B may apply the light emitting element initialization voltage VAINT to the fourth node N4B in response to the bias gate signal GB. In an embodiment, for example, the light emitting element initialization voltage VAINT may be lower than the second power supply voltage ELVSS. The light emitting element initialization voltage VAINT may be applied to the fourth node N4B, such that the black characteristic of the pixel circuit PXB may be improved.

The storage capacitor CSTB may include a first electrode that receives the first power supply voltage ELVDD and a second electrode connected to the first node NIB. The storage capacitor CSTB may store a voltage of the first node N1B.

The light emitting element EE may include a first electrode connected to the fourth node N4B and a second electrode that receives the second power supply voltage ELVSS. The light emitting element EE may emit light based on the driving current.

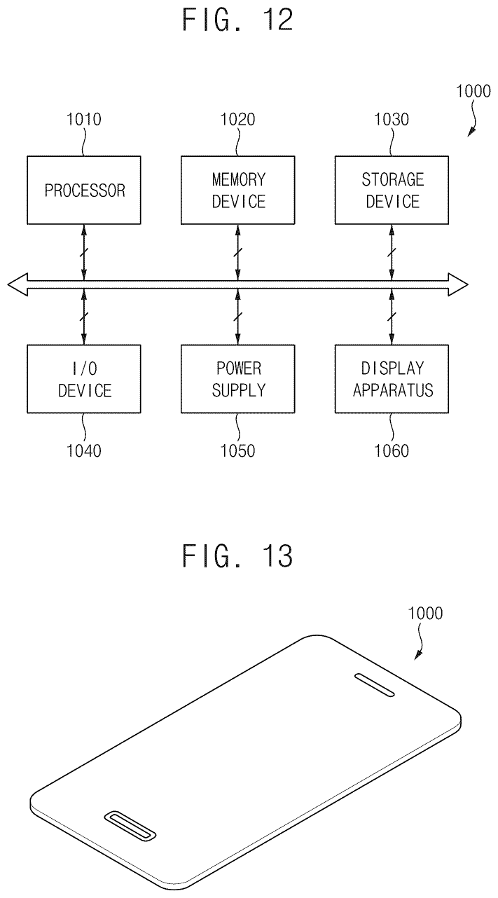

FIG. 12 is a block diagram illustrating an electronic apparatus 1000 according to an embodiment of the invention. FIG. 13 is a diagram illustrating an embodiment in which the electronic apparatus of FIG. 12 is implemented as a smart phone.

Referring to FIG. 12, an embodiment of the electronic apparatus 1000 may include a processor 1010, a memory device 1020, a storage device 1030, an input/output (I/O) device 1040, a power supply 1050, and a display apparatus 1060. In such an embodiment, the display apparatus 1060 may correspond to the display apparatus of FIG. 1. In an embodiment, the electronic apparatus 1000 may further include a plurality of ports for communicating with a video card, a sound card, a memory card, a universal serial bus (USB) device, other electronic apparatus, etc.

In an embodiment, as illustrated in FIG. 13, the electronic apparatus 1000 may be implemented as a smart phone. However, the electronic apparatus 1000 is not limited thereto. In an embodiment, for example, the electronic apparatus 1000 may be implemented as a cellular phone, a video phone, a smart pad, a smart watch, a tablet computer, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 13, an embodiment of the electronic apparatus may be implemented as a smartphone, but the invention is not limited thereto. The electronic apparatus may be a television, a monitor, a laptop computer, or a tablet computer. In an embodiment, the electronic apparatus may be a vehicle or an automobile.

The display apparatus according to the embodiments may be applied to a display apparatus included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel including a pixel; and
a display panel driver which drives the display panel,
wherein the display panel driver includes a voltage generator which applies a power voltage based on a power current to the display panel,
wherein when the pixel emits light, the voltage generator generates a compensation current, and
wherein the power voltage is applied to the display panel based on the compensation current.

2. The display apparatus of claim 1, wherein the display panel driver further includes:
an emission driver which outputs an emission signal; and
a driving controller which controls the voltage generator and the emission driver,
wherein the pixel emits light in response to the emission signal, and
wherein the compensation current is generated during a period in which the emission signal has an activation level.

3. The display apparatus of claim 2, wherein the driving controller outputs an emission start signal to the emission driver,
wherein the emission driver generates the emission signal based on the emission start signal, and
wherein the compensation current is generated based on the emission start signal.

4. The display apparatus of claim 2, wherein the driving controller outputs an emission start signal to the voltage generator,
wherein the emission driver generates the emission signal based on the emission start signal, and
wherein the compensation current is generated based on the emission start signal.

5. The display apparatus of claim 2, wherein the emission signal includes first to N-th emission signals,
wherein the first to N-th emission signals are generated based on an emission start signal and an emission clock signal from the driving controller, and
wherein the compensation current is generated based on the emission clock signal.

6. The display apparatus of claim 5, wherein when the emission clock signal has a clock low level, the compensation current is generated.

7. The display apparatus of claim 6, wherein a period in which the compensation current is generated is synchronized to the emission clock signal.

8. The display apparatus of claim 7, wherein the period in which the compensation current is generated is consistent with a period in which the emission clock signal has the clock low level.

9. The display apparatus of claim 1, wherein a frame period in which the pixel is driven includes a writing period in which a data voltage is applied and an emission period in which the pixel emits light based on the data voltage, and
wherein the compensation current is generated in the emission period.

10. The display apparatus of claim 1, wherein a frame period in which the pixel is driven includes a writing period in which a data voltage is applied and an emission period in which the pixel emits light based on the data voltage, and
wherein the voltage generator outputs the compensation current to the display panel in the emission period.

11. The display apparatus of claim 1, wherein the voltage generator includes:
a voltage receiving block which receives a supply voltage and outputs an output voltage based on the supply voltage;
a voltage compensation block which generates the compensation current based on an emission start signal; and
a voltage calculating block which outputs the power current based on the output voltage and the compensation current to the display panel.

12. The display apparatus of claim 1, wherein the voltage generator includes:
a voltage receiving block which receives a supply voltage and outputs an output voltage based on the supply voltage;
a voltage compensation block which generates the compensation current based on an emission clock signal; and
a voltage calculating block which outputs the power current based on the output voltage and the compensation current to the display panel.

13. The display apparatus of claim 1, wherein the voltage generator includes:
a voltage outputting block which receives a supply voltage and outputs the power current; and
a voltage compensation block which outputs the compensation current to the display panel in response to an emission start signal.

14. The display apparatus of claim 1, wherein the voltage generator includes:
a voltage outputting block which receives a supply voltage and outputs the power current;
a voltage compensation block which outputs the compensation current to the display panel in response to an emission clock signal.

15. The display apparatus of claim 1, wherein power voltage includes a first power voltage and a second power voltage, and the first power voltage is applied based on the power current,
wherein the pixel includes:
a first transistor which generates a driving current based on a data voltage;
a second transistor which applies the data voltage to the first transistor in response to a gate signal;
a third transistor which applies the first power voltage to the first transistor in response to an emission signal; and
a light emitting element which emits light based on the driving current.

16. A voltage generator comprising:
a voltage outputting block which receives a supply voltage and outputs a power current to a display panel; and
a voltage compensation block which generates a compensation current based on an emission clock signal,
wherein the compensation current is outputted in an emission period.

17. The voltage generator of claim 16, wherein the voltage outputting block includes:
a voltage receiving block which receives the supply voltage and outputs an output voltage based on the supply voltage; and
a voltage calculating block which receives the output voltage and the compensation current, and outputs the power current based on the output voltage and the compensation current.

18. The voltage generator of claim 16, wherein the voltage compensation block outputs the compensation current to the display panel.

19. A voltage generator comprising:
a voltage outputting block which receives a supply voltage and outputs a power current to a display panel; and
a voltage compensation block which generates a compensation current based on an emission start signal,
wherein the compensation current is outputted in an emission period.

20. The voltage generator of claim 19, wherein the voltage outputting block includes:
a voltage receiving block which receive the supply voltage and outputs an output voltage based on the supply voltage; and
a voltage calculating block which receive the output voltage and the compensation current, and outputs the power current based on the output voltage and the compensation current.

21. An electronic apparatus comprising:
a display panel including a pixel;
a display panel driver which drives the display panel based on an input control signal; and
a processor which outputs the input control signal,
wherein the display panel driver includes a voltage generator which applies a power voltage based on a power current to the display panel,
wherein when the pixel emits light, the voltage generator generates a compensation current, and
wherein the power voltage is applied to the display panel based on the compensation current.
